(19) United States
(12) Patent Application Publication
(10) Pub. No.: US 2008/0162318 A1
(43) Pub. Date: Jul. 3, 2008

(54) METHOD OF SECURELY TRANSFERRING FUNDS VIA A MOBILE INTERNET ENABLED DEVICE

(75) Inventors: Alfred Butler, Uxbridge, MA (US); Vadim Ivantsevich, Marlborough, MA (US); Anu Goutham, Northborough, MA (US)

Correspondence Address: Vern Maine & Associates, 100 MAIN STREET, P O BOX 3445, NASHUA, NH, 03061-3445, US

(73) Assignee: CYPHERMINT, INC., Marlborough, MA (US)

(21) Appl. No.: 11/968,779

(22) Filed: Jan. 3, 2008

Related U.S. Application Data
(60) Provisional application No. 60/878,345, filed on Jan. 3, 2007.

(51) Int. Cl. G06Q 20/00; H04L 9/32

(52) U.S. Cl. 705/35; 705/65; 705/44

(57) ABSTRACT

A method and system are provided for the transferring of money from a first account to a second account using a mobile device having: a mobile device coupled to a world wide distributed computer network; a service module coupled to the world wide distributed computer network via a communications protocol; a portal wallet coupled to the service module via a communications protocol; and a second account between which and the portal wallet money may be transferred such that money may be transferred to merchants from the portal wallet without exposing the second account's data to exposure.

### RELATED APPLICATIONS

This application claims the benefit of U.S. Provisional Application No. 60/878,345, filed Jan. 3, 2007. This application is herein incorporated in its entirety by reference.

### FIELD OF THE INVENTION

The invention relates to a unique method of securing real-time transfers of currency from a bank-secured funds repository in the form of a stored value card, to an electronic repository that can be controlled from any mobile web-enabled device.

### BACKGROUND OF THE INVENTION

Numerous electronic payment methods exist. One problem commonly associated with the use of debit card or credit card forms of payment is the substantial cost of the transaction to the merchant. For payments having a low value, such as micro-payments, the cost incurred by the transaction has the potential to be more than the actual payment. Thus, credit cards are not suitable for transactions involving micro-payments.

Recent developments in chip card technology have enhanced the security aspects of various payment models by linking a Personal Identification Number (or “PIN”) to a debit or credit card instead of a signature. However, the use of a PIN still requires the customer and the card to be physically present as the transaction is completed, and is appropriate, for example, for making purchases over the Internet.

To overcome these problems, credit card companies have introduced a process known as “card-holder not present” (or “CNP”) transactions. CNP transactions do not require a signature, however, the customer can potentially repudiate a completed transaction by disputing the transaction with the credit institution. Such repudiation can result in a financial loss to the involved merchant, rather than the credit card company. Also, since all of the customer's information is sent to a merchant, the customer is reliant on the merchant's security connection and infrastructure. Data stolen from a bad security environment runs the risk of identity theft. If the merchant's database is stolen or hacked, the thief or hacker can find out where the money came from. It is thus possible to steal or forge virtual cash.

Developments in the field of encryption technology suitable for electronic payments, including the Public Key Infrastructure and Secure Electronic Transactions process, have been proposed as a new standard for Internet transactions. However, both of these techniques require an extensive administrative and hardware infrastructure to manage the private keys and further, additional software must be installed on all customer equipment.

Another type of payment model for immediate receipt of funds in a cashless transaction includes electronic payment methods using a smart card. Smart cards incorporate a microprocessor which is embedded in the card and can interact with an ATM or a merchant smart card terminal to provide information about the cardholder or the cardholder's account or transaction authorization. Furthermore, the card can be included in a portable device such as a laptop computer, a cellular telephone, or a personal digital assistant.

One such method uses a smart card. A smart card typically includes a microchip that has storage capability and can store currency as an electronic credit. Such currency can be derived from a customer bank account and then represented in electronic form on the smart card. A paying party can electronically transfer this credit to the payee party on the other side of the transaction using a smart card reader. However, to conduct a transaction with a smart card, a smart card reader is necessary to complete the transaction.

There have been several attempts to produce devices and systems that can handle micro-payments and low value transactions without the overhead of standard credit cards or other similar types of financial products. These devices and systems can be generally divided into two classes, described below.

One class requires the use of additional devices or cards, such as the Mondex system, which is modeled after the paper bill and coin system. The Mondex system features a device, such as a smart card, having an embedded microprocessor that electronically stores money. After a customer actively loads money onto the card, the customer can use the card for purchases, by interacting the card with a smart card reader located at the point of sale. Therefore, this transfer ability requires all merchants to install these smart card readers, which are often expensive to purchase, install, and maintain. Also, customers must actively and continually load money onto their smart card, as the value of the card is depleted. This money gains no interest while it is on the card, and if the card is lost, the currency cannot be replaced.

The second classification of a device that can handle micro-payments includes based systems, including the system. The DigiCash system is designed to be used in combination with the Internet, and interacts with electronic currency that is stored directly on the customer's PC hardware. Thus, the system is not a mobile system of payment, and further, is not adapted for use without an active Internet connection.

Currently, for an electronic funds transfer to occur, the account holder installs software on a personal computer, which in turn allows account management by sending money management requests via the installed software. The account holder is always dealing with abstract numbers, which are not secured by any kind of physical or virtual entity. These bank account-based funds use a single two-parameter (currency and amount) object; both of the parameters are variables. Any operation could change both of the parameters without changing the object or creating a new one. This opens the door to lots of illegal activities; the account holder is basically in the hands of the bank.

A stored value card is a card that is purchased or provided with a specific monetary amount, which is stored on the card. The monetary amount may be encoded on a magnetic strip or recorded in some other manner. When the cardholder desires to use the stored value card to purchase goods or services, the card is presented at the point of sale and the cost of the goods or services purchased is deducted from the value of the card.

What is needed, therefore, are techniques for transferring money between virtual accounts without exposing those accounts to fraud or counterfeiting.

### SUMMARY OF THE INVENTION

One embodiment of the present invention provides a system for the transferring of money from a first account to a second account using a mobile device, the system comprising: a mobile device coupled to a world wide distributed computer network; a service module coupled to the world wide distributed computer network via a communications protocol; a portal wallet coupled to the service module via a communications protocol; and a second account between which and the portal wallet money may be transferred such that money may be transferred to merchants from the portal wallet without exposing the second account's data to exposure.

Another embodiment of the present invention provides such a system wherein the portal wallet is configured by a user utilizing a web based browser.

A further embodiment of the present invention provides such a system wherein the portal wallet and the second account are disposed on a secure server system.

Still another embodiment of the present invention provides such a system wherein the portal wallet comprises a custom interface configured by the user for use with the mobile device.

A still further embodiment of the present invention provides such a system wherein the second account is a stored value account.

Yet another embodiment of the present invention provides such a system wherein the stored value account comprises a stored value account selected from the group of stored value accounts consisting of bank accounts, declining deposit accounts, debit accounts, and gift card accounts.

A yet further embodiment of the present invention provides such a system wherein the transfer is conducted between the portal wallet and the second account via an encrypted connection.

Even another embodiment of the present invention provides such a system wherein the encrypted connection is subject to an industry standard encryption.

An even further embodiment of the present invention provides such a system wherein the encryption connection is subject to a proprietary encryption protocol.

Still yet another embodiment of the present invention provides such a system wherein the portal wallet provides access to a virtual account.

One embodiment of the present invention provides a method for the electronic transfer of funds, the method comprising: Turing a mobile device on wherein the mobile device is equipped with a payment application whereby preset prompts of non-confidential data defined by a user are presented to the user; Logging into the payment application; Receiving a list of possible commands; Entering an amount to be transferred; Transferring the amount through a secure payment account application service; Verifying sufficiency of user funds available in a first account; Retrieving account number of a second account; Connecting to the second account; and Transferring the amount from the first account to the second account; wherein either the first or the second account is a virtual account.

Another embodiment of the present invention provides such a method wherein the method further comprises after entering the amount to be transferred, entering a virtual account identification number for the second account.

A further embodiment of the present invention provides such a method wherein the method further comprises after entering the amount to be transferred, entering an alias representing an account identification number.

Still another embodiment of the present invention provides such a method wherein the method further comprises after entering the amount to be transferred, entering an alias representing a cellular telephone number.

A still further embodiment of the present invention provides such a method wherein the mobile device is a mobile phone.

Even another embodiment of the present invention provides such a method wherein both the first and the second accounts are virtual accounts.

An even further embodiment of the present invention provides such a method wherein the second account is a stored value account.

Yet another embodiment of the present invention provides such a method wherein the stored value account is selected from the group of stored value accounts consisting of checking accounts, savings accounts, and gift card accounts.

A yet further embodiment of the present invention provides such a method wherein the application is an application selected from the group of applications consisting of web enabled browsers and dedicated payment applications.

Still yet another embodiment of the present invention provides such a method wherein the mobile device is configured for short message service.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow chart showing the process for account management in one embodiment of the invention.

FIG. 2 is a diagram illustrating a transfer from a virtual account to a stored value account in a first embodiment of the invention.

FIG. 3 is a flowchart showing the process flow for a transfer from a virtual account to a stored value account on a stored value card in the first embodiment of the invention.

FIG. 4 is a diagram illustrating a transfer from a stored value account to a virtual account using a mobile device in a second embodiment of the invention.

FIG. 5 is a flowchart showing the process flow for a transfer from a stored value account to a virtual account in the second embodiment of the invention.

FIG. 6 is a diagram illustrating a transfer from one virtual account to another virtual account using a mobile device in a third embodiment of the invention.

FIG. 7 is a flow chart showing the process flow for a transfer one virtual account to another virtual account in the third embodiment of the invention.

### DETAILED DESCRIPTION

The embodiments of the invention are directed to various electronic transfers of using a mobile device. The transfers are secure despite being able to operate via the Internet. Direct account-to-account communications, together with security algorithms and blind signatures enable the security. The funds are taken from one repository that are controlled by the account holder (the user of the mobile device) to generate a secure value card. The card has a fixed unchangeable identity and a fixed value and acts as a virtual substitute for cash. The receiver of the card has the ability to withdraw the actual cash, up to the limit stated. However, a user or hacker cannot access the identity or account of the source of the value card. Optionally, the card may have only single use limit, preventing repetition as a hacking tool.

The embodiments are implemented with the use of a mobile server and an Internet-based application or a software or firmware application which may be installed on an Internet enabled mobile device. From the standpoint of the user, the service is provided by a party which is not a financial institution. In the accompanying drawings, the service and service provider are referred to using the moniker “PayCash”.

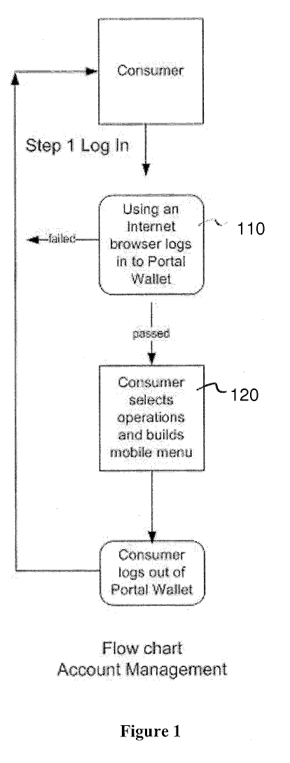

The customer is enabled to manage the service as shown in FIG. 1. The service is initiated by having the customer log into an Internet-based portal 110 to create a virtual account (portal wallet). If the effort is successful, the customer can configure the services they desire and account information 120. The customer has the ability to select the operations and services, and build a preferred mobile menu of operations and services. The initiation and configuration is, in one embodiment, able to be accomplished with any commercially available web browsers, and need not be done on the mobile device used to accomplish the transfers. When finished, the customer logs out of the portal 130. The portal continues to be available to the customer so as to provide account management.

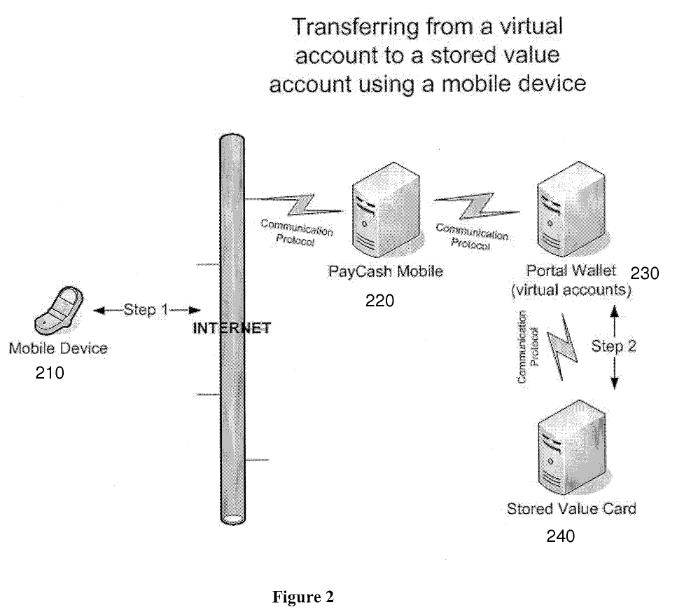

FIG. 2 depicts the elements involved in electronically transferring a virtual account to a stored value account. In addition to the mobile device 210 and the mobile server 220 of the party offering the transfer service serving the mobile device, there will also be a virtual account (portal wallet) 230 corresponding to the customer and a stored value card 240. One or more of the servers may be programmed using a suitable comprehensive framework that contemplates electronic commerce, such as the .NET framework available from Microsoft Corporation of Redmond, Wash., rather than, for example, JAVA elements.

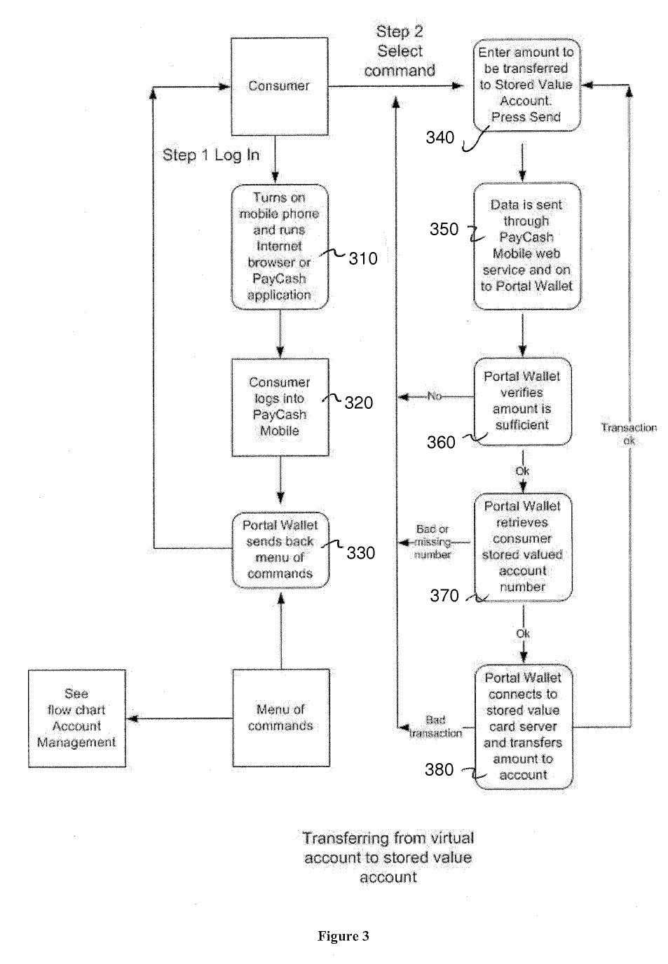

FIG. 3 shows the process flow for the transfer. First, the user turns on the Internet-enabled mobile device 210 and starts either the Internet browser or the application provided by the service provider 310. The consumer must log into the service 320. The portal 220 takes the menu of commands, as determined by the configuration of the user in step 120, and sends it through mobile server 220 back to the mobile device 210, 330.

The user enters or otherwise inputs the account number of their virtual account and a value to be transferred at the mobile device 210 and presses send 340. Then, a communication signal containing the data is sent to mobile server 220 and, from there, the mobile server 220 sends a communication signal onto the virtual account server 230 that holds the virtual account for processing 350. If the balance of the virtual account is not sufficient, then an error is returned back to the user 360. If the balance is sufficient, then the portal 230 retrieves the consumer's stored value account number 370. If the account number is bad or missing, then an error is returned back to the user. If the account number is OK, the portal 230 connects to the stored value card server 240, and attempts to transfer the entered value to the stored value card account 380. Either an error message or a success message is returned back to the user to indicate the result of the transaction.

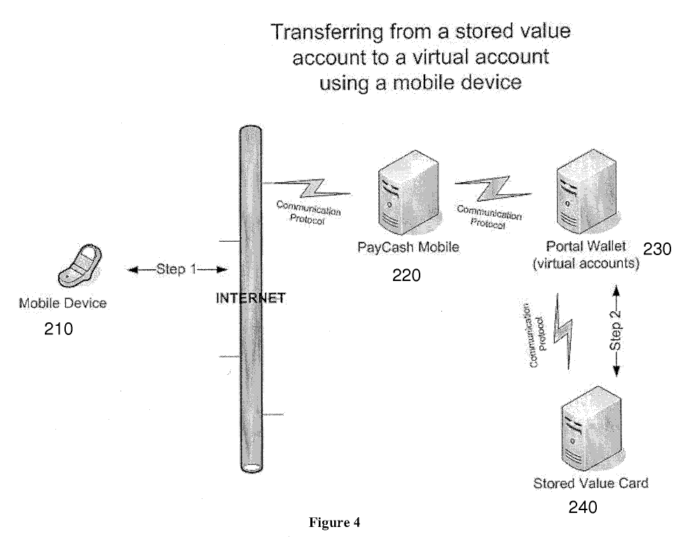

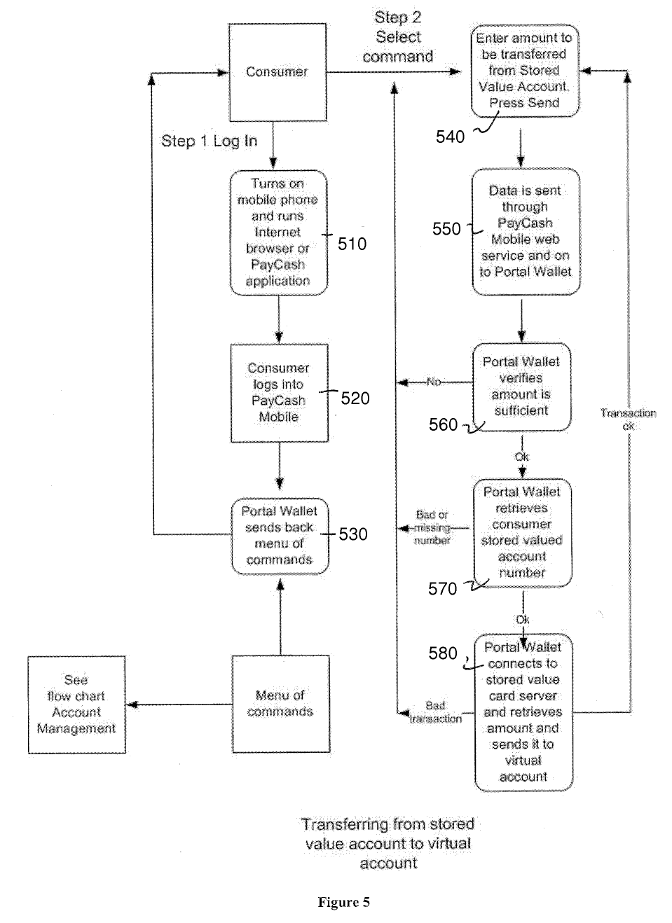

FIG. 4 depicts the elements involved in electronically transferring from a stored value account to a virtual account using mobile device 210 and FIG. 5 shows the process flow for the transfer. The devices are the same. The process is largely the same and steps 510-530 and 550-570 are the same as steps 310-330 and 350-370, respectively. The only difference is that, at entry step 540, the user indicates that the transfer is from the stored value account (rather than to the stored value account), and at step 580, the amount is retrieved from the stored value account (rather than to the stored value account).

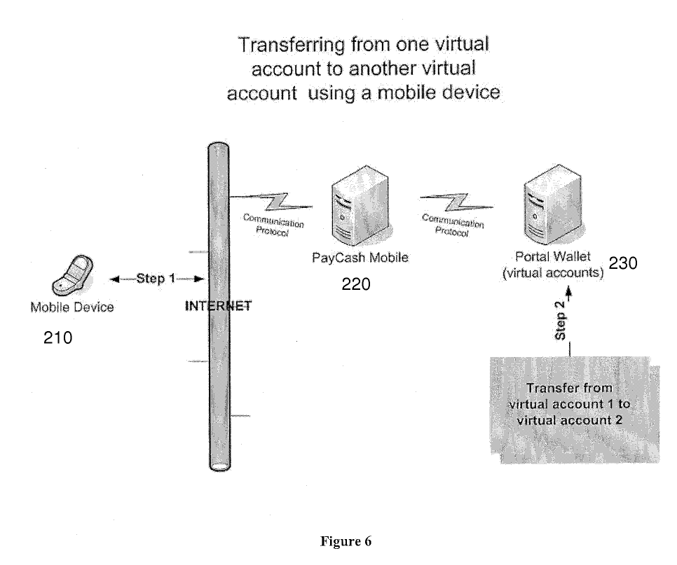

FIG. 6 depicts the elements involved in electronically transferring funds from one virtual account to another virtual account using a mobile device. Both virtual accounts are maintained by virtual account server 230. In such an instance, stored value account server 240 is not present. It is contemplated that no financial institution is needed for the transfer.

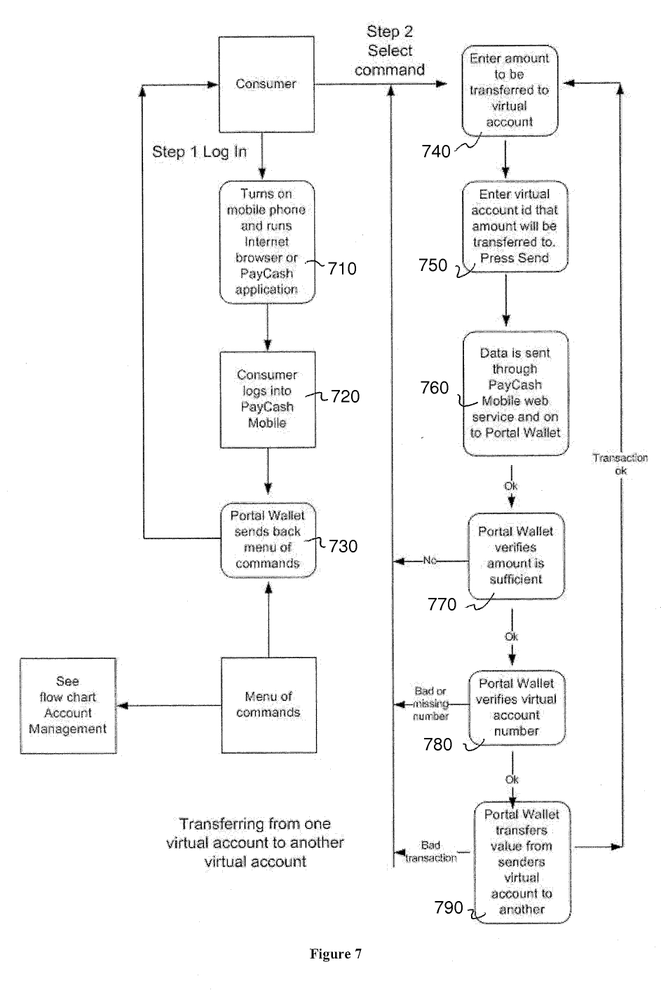

FIG. 7 shows the process steps involved for the transfer. The process is largely the same and steps 710-730 are the same as steps 310-330, respectively. Again, the user enters or otherwise inputs from the mobile device 210, the amount to be transferred as well as their virtual account numbers involved in the amount transfer 740. The user also enters the virtual account ID of the virtual account to which the amount will be transferred 750. Then, a communication signal containing the data is sent to mobile 220 and, from there, the mobile server 220 sends a communication signal onto the virtual account server 230 that holds the virtual accounts for processing 760. If the balance of the virtual account is not sufficient, then an error is returned back to the user 770. If the balance is sufficient, then the portal 230 verifies the virtual account number 780. If the virtual account number is bad or missing, then an error is returned back to the user. If the account number is OK, the portal 230 attempts to transfer the entered value from the sender's virtual account to the other virtual account 790. Either an error message or a success message is returned back to the user to indicate the result of the transaction.

A mobile funds transfer process such as described above differs from conventional processes insofar as, instead of issuing direct orders to the bank via bank-supplied software, it relies on peer-to-peer transactions within accounts, which are initiated via a web-enabled device and secured through robust security algorithms. The result is full control of funds flowing from and to the customer's virtual account (processing center) and another electronic virtual account funds repository, controlled by the account holder via a mobile web-enabled device. Neither party needs to have a banking relationship.

Furthermore, the process, in one embodiment, uses a blind digital signature technology, such as that described in U.S. Pat. No. 7,058,808, which is hereby incorporated by reference in its entirety. Every transfer operation uses a virtual cash object with a fixed ID and a currency value. Unlike bank-initiated transfers, these objects can be used only once, making forgery extremely improbable.

A double blind security system is, in one embodiment, automatically invoked for all transfers and does not need to be specified or requested by the user. All of these devices are communicating with each other by encrypted messages. Each message is encrypted either with a public key of a receiving party or with a symmetric session key provided in the previous message. It is contemplated that there is a non-trust relationship between the parties. Every request is accompanied with an electronic signature of the sender and a copy of the signature of the sender is stored at the recipient's location. Also, the information about the result of the transfer is stored at the sender's location accompanied with electronic signatures of both parties.

A unique aspect of the process is that funds can be transferred from one party's account to another without the intervention of a banking system during the transfer. Known as a virtual account or a virtual wallet, the process removes the dependency of a third-party system such as a bank and enables users to quickly transfer virtual funds using a mobile device.

Unlike conventional methods, in the various embodiments of the invention, if the merchant's database is stolen, a thief or hacker cannot find out where the money came from. It is impossible to steal or forge virtual cash, at least without stealing the entire back-end infrastructure.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for the transferring of money from a first account to a second account using a mobile device, the system comprising:
A mobile device coupled to a world wide distributed computer network;
A service module coupled to said world wide distributed computer network via a communications protocol;
A portal wallet coupled to said service module via a communications protocol; and
A second account between which and said portal wallet money may be transferred such that money may be transferred to merchants from said portal wallet without exposing said second account's data to exposure.

2. The system of claim 1 wherein said portal wallet is configured by a user utilizing a web based browser.

3. The system according to claim 1 wherein said portal wallet and said second account are disposed on a secure server system.

4. The system according to claim 1 wherein said portal wallet comprises a custom interface configured by the user for use with said mobile device.

5. The system according to claim 1 wherein said second account is a stored value account.

6. The system according to claim 5 wherein said stored value account comprises a stored value account selected from the group of stored value accounts consisting of bank accounts, declining deposit accounts, debit accounts, and gift card accounts.

7. The system according to claim 1 wherein said transfer is conducted between said portal wallet and said second account via an encrypted connection.

8. The system according to claim 7 wherein said encrypted connection is subject to an industry standard encryption.

9. The system according to claim 7 wherein said encryption connection is subject to a proprietary encryption protocol.

10. The system according to claim 1 wherein said portal wallet provides access to a virtual account.

11. A method for the electronic transfer of funds, said method comprising:
Turing a mobile device on wherein said mobile device is equipped with a payment application whereby preset prompts of non-confidential data defined by a user are presented to said user;
Logging into said payment application;
Receiving a list of possible commands;
Entering an amount to be transferred;
Transferring said amount through a secure payment account application service;
Verifying sufficiency of user funds available in a first account;
Retrieving account number of a second account;
Connecting to said second account; and
Transferring said amount from said first account to said second account; wherein either said first or said second account is a virtual account.

12. The method according to claim 11 wherein said method further comprises after entering said amount to be transferred, entering a virtual account identification number for said second account.

13. The method according to claim 11 wherein said method further comprises after entering said amount to be transferred, entering an alias representing an account identification number.

14. The method according to claim 11 wherein said method further comprises after entering said amount to be transferred, entering an alias representing a cellular telephone number.

15. The method according to claim 11 wherein said mobile device is a mobile phone.

16. The method according to claim 11 wherein both said first and said second accounts are virtual accounts.

17. The method according to claim 11 wherein said second account is a stored value account.

18. The method according to claim 17 wherein said stored value account is selected from the group of stored value accounts consisting of checking accounts, savings accounts, and gift card accounts.

19. The method according to claim 11 wherein said application is an application selected from the group of applications consisting of web enabled browsers and dedicated payment applications.

20. The method according to claim 11 wherein said mobile device is configured for short message service.
